(19) United States
(12) Patent Application Publication
(10) Pub. No.: US 2025/0155869 A1
(43) Pub. Date: May 15, 2025

(54) DEVICE FOR PERFORMING NUMERIC CONTROL OF MACHINE TOOL

(71) Applicant: FANUC CORPORATION, Yamanashi (JP)

(72) Inventors: Toshihiro WATANABE, Yamanashi (JP); Junichiro KONO, Yamanashi (JP)

(73) Assignee: FANUC CORPORATION, Yamanashi (JP)

(21) Appl. No.: 18/838,798

(22) PCT Filed: May 10, 2022
(86) PCT No.: PCT/JP2022/019788

§ 371 Date: Aug. 15, 2024

(51) Int. Cl. G05B 19/4093; G05B 19/18

(52) U.S. Cl. CPC G05B 19/40932; G05B 19/182

(57) ABSTRACT

The present invention provides a device for performing numeric control of a machine tool, wherein said device generates an outward-direction cutting action and a return-direction cutting action. In the device for performing numeric control of a machine tool, a tool and a workpiece are caused to move back and forth relative to one another while the tool and workpiece are caused to rotate relative to each other, so that the workpiece is cut by both the outward direction cutting action and the return direction cutting action, the device for performing numerical control of a machine tool comprising: a removal region input unit that analyzes a cutting program and reads the shape of the workpiece removal region to be removed by cutting; a processing criteria input unit that reads the processing criteria for cutting including at least the cutting depth of the tool in the outward direction cutting action and the cutting depth of the tool in the return direction cutting action; and an action generating unit that generates the outward direction cutting action and the return direction cutting action so that, on the basis of the removal region shape and processing criteria, the tool intersects the uncut portion of the removal region, and the intersecting amount does not exceed the outward direction cutting depth and the return direction cutting depth in the processing criteria.

### TECHNICAL FIELD

The present invention relates to a numerical controller for a machine tool.

### BACKGROUND ART

In a known technique for controlling a machine tool, while a workpiece is rotated, a tool is moved relative to the workpiece to perform cutting operation of the workpiece, based on a machining program. It has been known that in such a technique, a tool is repeatedly reciprocated relative to a workpiece to perform cutting processing in a forward direction a plurality of separate times, for example. See, for example, Patent Document 1.

### Citation List

### Patent Document

Patent Document 1: Japanese Unexamined Patent Application, Publication No. 2005-288563

### DISCLOSURE OF THE INVENTION

### Problems to be Solved by the Invention

In such a technique in which a workpiece is cut a plurality of separate times as described above, the machining time has been expected to be shortened. To meet this expectation, a cutting operation may be performed not only in the forward direction but also in the return direction.

Unfortunately, a numerical controller achieving both the cutting operations in the forward direction and in the return direction requires specification of positions and the amount of movement in each of the cutting operations in the forward direction and in the return direction in a machining program with consideration given to the depth of cut in each of the cutting operations in the forward direction and in the return direction. It is difficult to create such a machining program in a manual manner. The more complicated the machined shape becomes, the higher the degree of difficulty in creating the machining program in a manual manner. Using programming support software, such as computer-aided manufacturing (CAM), would enable relatively easy creation of a machining program. However, introduction of such software is expensive. To address this problem, a numerical controller has been expected to generate both cutting operations in the forward direction and in the return direction while the cost of introduction of programming support software is reduced.

### Means for Solving the Problems

An aspect of the present disclosure is directed to a numerical controller for a machine tool that performs cutting processing of a workpiece by both a cutting operation in a forward direction and a cutting operation in a return direction by relatively rotating a tool and the workpiece while relatively reciprocating the tool and the workpiece. The numerical controller includes: a removal region input unit configured to analyze a program for the cutting processing, and to read a shape of a removal region of the workpiece to be removed by the cutting processing; a machining condition input unit configured to read machining conditions for the cutting processing, the machining conditions including at least a depth of cut to be made by the tool in the cutting operation in the forward direction and a depth of cut to be made by the tool in the cutting operation in the return direction; and a motion generator configured to generate the cutting operation in the forward direction and the cutting operation in the return direction, based on the shape of the removal region and the machining conditions, such that the tool intersects with a yet-to-be-cut portion of the removal region and such that an amount of intersection does not exceed the depth of cut to be made by the tool in the forward direction and the depth of cut to be made by the tool in the return direction.

### Effects of the Invention

According to the aspect, the numerical controller can generate both the cutting operation in the forward direction and the cutting operation in the return direction while the cost of introduction of software is reduced. This can shorten the machining time.

### BRIEF DESCRIPTION OF THE DRAWINGS

FIG. 1 illustrates an exemplary numerical controller for a machine tool according to an embodiment;

FIG. 2A shows an exemplary machining program for cutting into any shape with a contour including straight portions and a curved portion;

FIG. 2B shows exemplary descriptions of the machining program shown in FIG. 2A;

FIG. 3A is a cross-sectional view illustrating the shape of a removal region indicated by the machining program shown in FIG. 2A and a portion (a half portion above the rotation axis Z) of the contour shape of a machined workpiece;

FIG. 3B is a cross-sectional view illustrating the shape of the removal region indicated by the machining program illustrated in FIG. 2A and a portion (a half portion above the rotation axis Z) of the contour shape of the machined workpiece;

FIG. 4A shows an exemplary machining program for cutting into any shape with a contour including straight portions and a curved portion;

FIG. 4B shows exemplary descriptions of the machining program shown in FIG. 4A;

FIG. 5A shows an exemplary machining program for cutting into any shape with a contour including straight portions and a curved portion;

FIG. 5B is an exemplary table showing tool identifying information and machining conditions for machining with each of tools;

FIG. 6A illustrates exemplary cutting operations of a tool in the forward direction and in the return direction generated by a motion generator;

FIG. 6B illustrates exemplary cutting operations of a tool in the forward direction and in the return direction generated by the motion generator;

FIG. 6C illustrates exemplary cutting operations of a tool in the forward direction and in the return direction generated by the motion generator;

FIG. 7A illustrates exemplary approach motions generated by the motion generator;

FIG. 7B illustrates exemplary approach motions generated by the motion generator;

FIG. 8A illustrates exemplary switching motions between the cutting operations in the forward direction and the cutting operations in the return direction, generated by the motion generator;

FIG. 8B illustrates exemplary switching motions between the cutting operations in the forward direction and the cutting operations in the return direction, generated by the motion generator;

FIG. 9A illustrates exemplary outfeed motions along the removal region, generated by the motion generator;

FIG. 9B illustrates other exemplary outfeed motions along the removal region, generated by the motion generator;

FIG. 10 illustrates exemplary escape motions and exemplary approach motions after the outfeed motions, generated by the motion generator;

FIG. 11A illustrates exemplary outfeed motions and exemplary infeed motions generated by the motion generator;

FIG. 11B illustrates exemplary outfeed motions and exemplary infeed motions generated by the motion generator;

FIG. 12A illustrates exemplary escape motions and exemplary approach motions at the end of machining, generated by the motion generator;

FIG. 12B illustrates exemplary escape motions and exemplary approach motions at the end of machining, generated by the motion generator;

FIG. 13A shows an exemplary machining program for cutting into a shape with only a straight contour, i.e., a rectangular removal region;

FIG. 13B shows an exemplary machining program for cutting into a shape with only a straight contour, i.e., a removal region including a combination of a rectangular shape and tapered shapes (right-angled triangular shapes);

FIG. 13C shows an exemplary machining program for cutting into a shape with only a straight contour, i.e., a tapered (right-angled triangular) removal region;

FIG. 13D shows exemplary descriptions of the machining programs shown in FIGS. 13A to 13C;

FIG. 14A is a cross-sectional view illustrating the shape of the removal region indicated by the machining program shown in FIG. 13A and a portion (a half portion above the rotation axis Z) of the contour shape of the machined workpiece;

FIG. 14B is a cross-sectional view illustrating the shape of the removal region indicated by the machining program shown in FIG. 13A and a portion (a half portion above the rotation axis Z) of the contour shape of the machined workpiece;

FIG. 14C is a cross-sectional view illustrating the shape of the removal region indicated by the machining program shown in FIG. 13A and a portion (a half portion above the rotation axis Z) of the contour shape of the machined workpiece;

FIG. 14D is a cross-sectional view illustrating the shape of the removal region indicated by the machining program shown in FIG. 13B and a portion (a half portion above the rotation axis Z) of the contour shape of the machined workpiece;

FIG. 14E is a cross-sectional view illustrating the shape of the removal region indicated by the machining program shown in FIG. 13C and a portion (a half portion above the rotation axis Z) of the contour shape of the machined workpiece;

FIG. 15 illustrates exemplary cutting operations of a tool in the forward direction and in the return direction generated by a motion generator according to a variation of the embodiment;

FIG. 16 illustrates exemplary cutting operations of a tool in the forward direction and in the return direction generated by a motion generator according to a variation of the embodiment;

FIG. 17 illustrates exemplary rotating motions of a tool and a workpiece and exemplary cutting operations in the forward direction and in the return direction according to a variation of the embodiment;

FIG. 18A shows a machining program according to a variation of the embodiment, which is an exemplary machining program that enables cutting into a shape with a contour including only one curve; and

FIG. 18B is a cross-sectional view illustrating the shape of a removal region indicated by the machining program shown in FIG. 18A and a portion (a half portion above a rotation axis Z) of the contour shape of a machined workpiece.

### PREFERRED MODE FOR CARRYING OUT THE INVENTION

Exemplary embodiments of the present invention will be described below with reference to the accompanying drawings. The same reference numerals are used to represent identical or equivalent elements in figures.

### First Embodiment

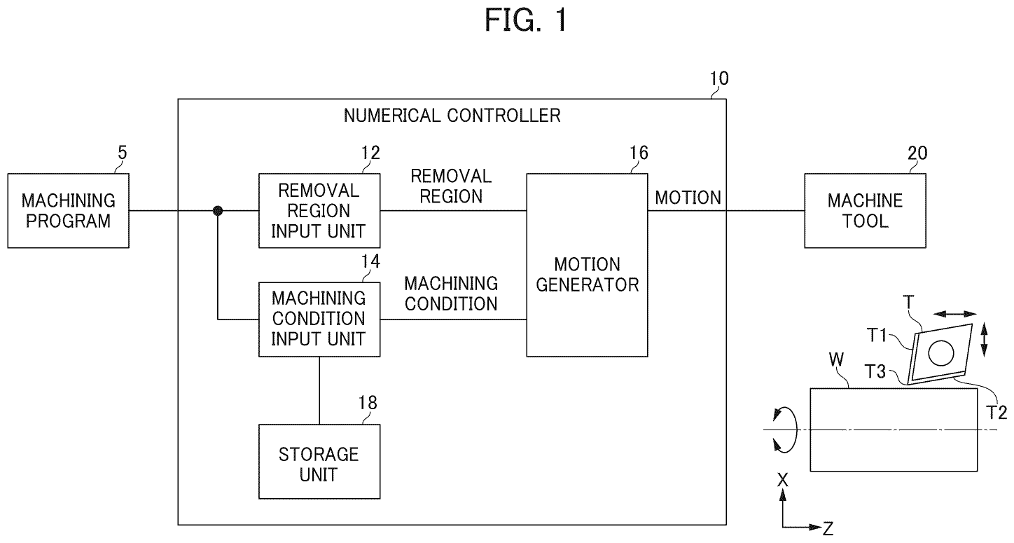

FIG. 1 illustrates an exemplary numerical controller for a machine tool according to an embodiment. A numerical controller 10 illustrated in FIG. 1 controls motions of a machine tool 20, specifically, cutting motions of a tool T for a workpiece W, based on a machining program 5.

Examples of the workpiece W include a circular cylindrical workpiece, a cylindrical workpiece, a conical workpiece, and a truncated conical workpiece. In FIG. 1 and figures to be described later, the central axis of the workpiece W serving as the rotation axis of the workpiece is indicated by a “Z axis”, and the axis perpendicular to the Z axis is indicated by an “X axis”.

The machine tool 20 performs cutting operation of the workpiece W using the tool T. Specifically, the machine tool 20 reciprocates the tool T along the Z axis or along the resultant of the Z and X axes while the workpiece W is rotated around the Z axis. In this manner, the workpiece W is cut. The machine tool 20 performs cutting operation of the workpiece W through both a cutting operation in the forward direction (e.g., in the −Z direction) and a cutting operation in the return direction (e.g., in the +Z direction). Examples of such a tool T include a tool including two blades T1 and T2.

The machine tool 20 can machine a workpiece not only with a straight shape but also with a circular shape in a direction along the Z axis. The machine tool 20 can machine the inner peripheral surface of a workpiece, such as a cylindrical workpiece, as well as the outer peripheral surface of a workpiece.

The numerical controller 10 controls a rotating motion of the workpiece W, and controls a shifting motion of the edge T3 of the tool T. How the shifting motion of the edge T3 of the tool T is controlled will now be described in detail. The numerical controller 10 includes a removal region input unit 12, a machining condition input unit 14, a motion generator 16, and a storage unit 18.

Components of the numerical controller 10 (except the storage unit 18) are each configured as an arithmetic processor, such as a central processing unit (CPU), a digital signal processor (DSP), or a field-programmable gate array (FPGA). The components of the numerical controller 10 (except the storage unit 18) have various functions that are implemented through execution of predetermined software (a predetermined program) stored in the storage unit 18, for example. The components of the numerical controller 10 (except the storage unit 18) may have various functions that are implemented either through cooperation between hardware and software or through only hardware (an electronic circuit).

The storage unit 18 is configured as a memory, such as a read only memory (ROM), a hard disk drive (HDD), or a solid state drive (SSD). The storage unit 18 stores predetermined software (a predetermined program) for implementing the various functions of the components of the numerical controller 10 described above.

In this embodiment, the machining program 5 includes the shape of the removal region of the workpiece W to be removed by cutting processing (i.e., the contour shape of the cut workpiece W) and machining conditions for cutting processing. The removal region input unit 12 analyzes the machining program 5, and reads the shape of the removal region of the workpiece W. The machining condition input unit 14 analyzes the machining program 5, and reads the machining conditions for cutting. The machining program 5, the removal region input unit 12, and the machining condition input unit 14 will now be described in detail.

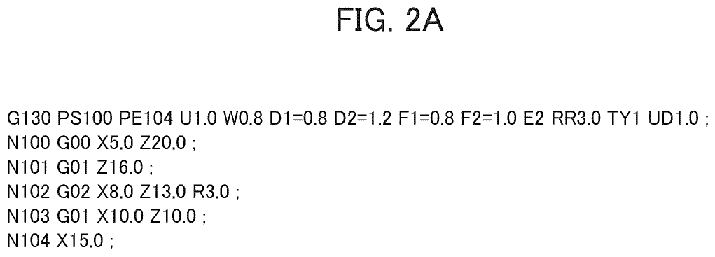

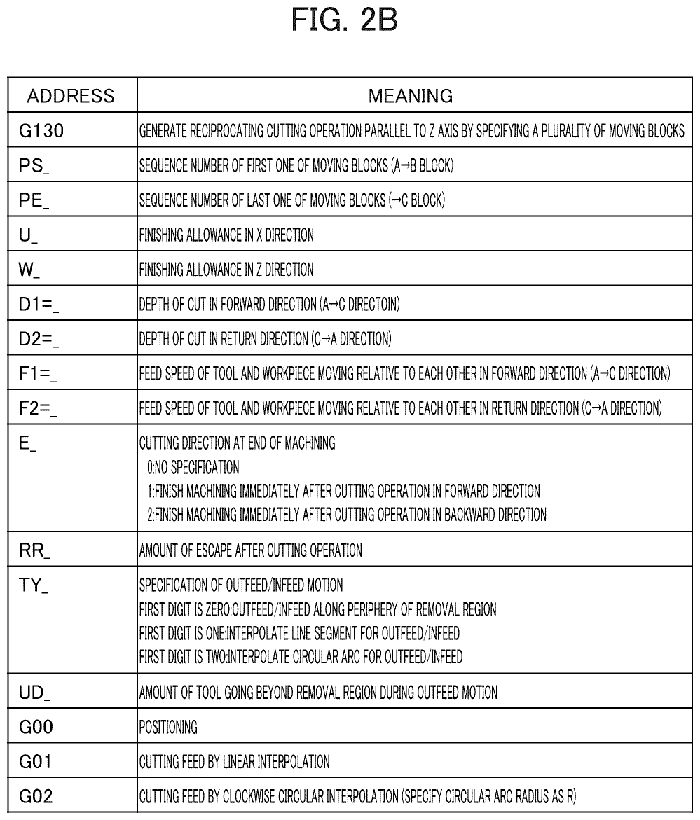

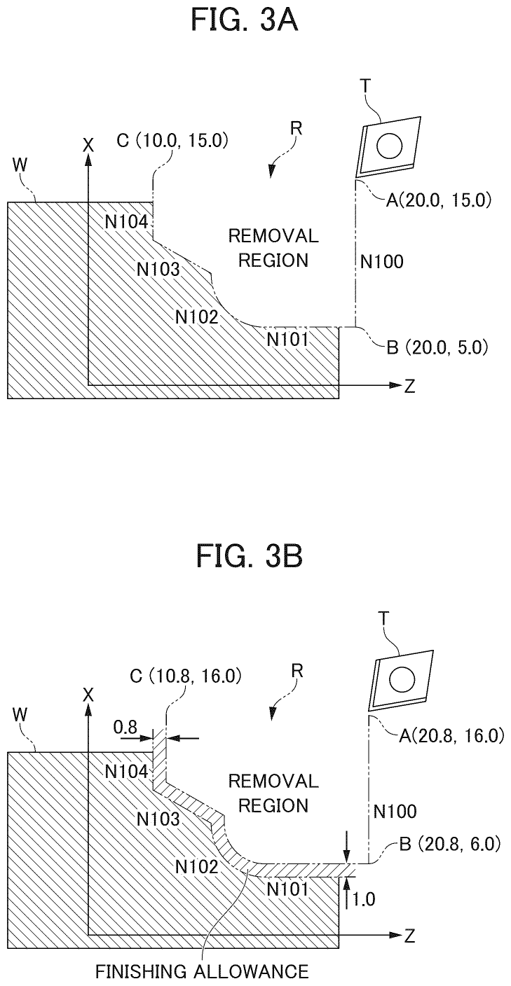

FIG. 2A shows an exemplary machining program for cutting into any shape with a contour including straight portions and a curved portion, and FIG. 2B shows exemplary descriptions of the machining program shown in FIG. 2A. FIGS. 3A and 3B are each a cross-sectional view illustrating the shape of a removal region indicated by the machining program shown in FIG. 2A and a portion (a half portion above the rotation axis Z) of the contour shape of a machined workpiece.

As shown in FIGS. 2A, 2B, and 3A,

G130 represents a command that generates a reciprocating cutting operation parallel to the Z axis by specifying a plurality of moving blocks N100 to N104.
PS_ represents the sequence number of the first one of the moving blocks (the moving block N100 indicating a motion of A→B).
PE_ represents the sequence number of the last one of the moving blocks (the moving block N104 indicating a motion of →C).
U_ represents a finishing allowance for finishing in the X direction.
W_ represents a finishing allowance for finishing in the Z direction.
G00 represents a command for positioning.
G01 represents a command for cutting feed performed by linear interpolation.
G02 represents a command for cutting feed performed by clockwise circular interpolation (where R specifies the circular arc radius).

As shown in FIGS. 2A and 3A,

the moving block N100 indicates a positioning shift from a shift starting point A (Z=20.0, X=15.0) to a point B (Z=20.0, X=5.0),
the moving block N101 indicates a shift for cutting feed performed by linear interpolation from the point B (Z=20.0, X=5.0) to the position Z=16.0 in the Z direction,
the moving block N102 indicates a further shift for cutting feed performed by clockwise circular interpolation to the position Z=13.0 in the Z direction, where the circular arc radius R is 3.0,
the moving block N103 indicates a further shift for cutting feed performed by linear interpolation to the position (Z=10.0, X=10.0), and
the moving block N104 indicates a further shift for cutting feed performed by linear interpolation to the position X=15.0 in the X direction, i.e., a shift end point C (Z=10.0, X=15.0).
The coordinate value of the X axis should be prevented from decreasing between the points B and C.

As can be seen, the moving blocks N100 to N104 show the contour shape of the removal region R of the workpiece W defined by one or more of straight lines and curves, i.e., the contour shape of the cut workpiece W. If the finishing allowances (U, W) are specified, the moving blocks N100 to N104 show the contour shape of the removal region R of the finished workpiece W, i.e., the contour shape of the cut workpiece W. As can be seen, the machining program includes the contour shape of the removal region R of the workpiece W to be removed by cutting processing, i.e., the contour shape of the cut workpiece W.

In this case, the removal region input unit 12 analyzes the machining program, and reads the shape of the removal region R of the workpiece W to be removed by cutting processing, from the contour shape of the removal region in the machining program. For example, in the case of the command G130 shown in FIGS. 2A and 3A, the removal region input unit 12 reads the inside of a region surrounded by the points A-B-C as the removal region R from the moving blocks N100 to N104. Alternatively, as shown in FIGS. 2A and 3B, if the finishing allowances (U, W) are specified, the removal region input unit 12 further reads the finishing allowances (U, W) from the machining program, and shifts, i.e., translates the read removal region R in the X and Z directions by the corresponding finishing allowances.

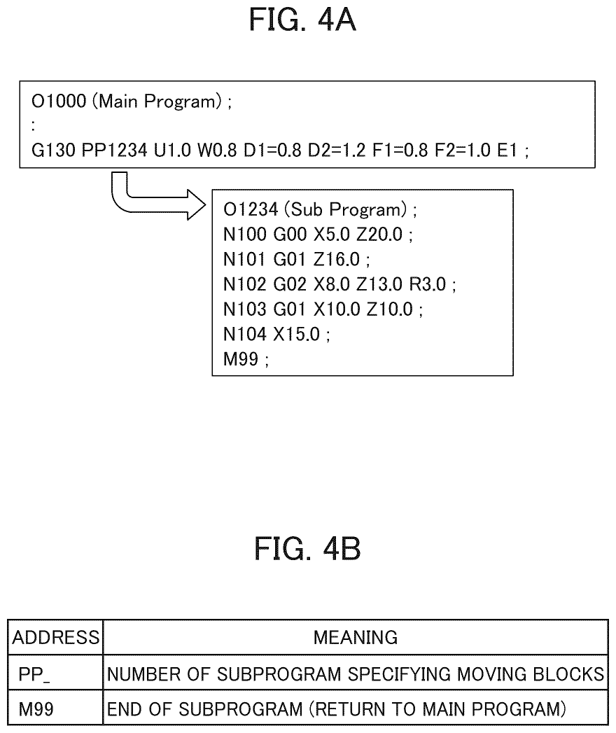

FIG. 4A shows an exemplary machining program for cutting into any shape with a contour including straight portions and a curved portion, and FIG. 4B shows exemplary descriptions of the machining program shown in FIG. 4A. As shown in FIGS. 4A and 4B, the moving blocks N100 to N104 may be provided in the form of a subprogram.

PP_ represents a subprogram number that specifies moving blocks (the finished shape).
M99 indicates the end of the subprogram (return to the main program).

Referring to FIGS. 2A and 2B again, the machining program includes machining conditions for cutting processing. D1_ represents the depth of cut made by the tool T in the cutting operation in the forward direction (A→C direction), and D2_ represents the depth of cut made by the tool T in the cutting operation in the return direction (C→A direction).

F1_ represents the feed speed of the tool T in the cutting operation in the forward direction (A→C direction), and F2_ represents the feed speed of the tool T in the cutting operation in the return direction (C→A direction).
E_ represents the cutting direction at the end of machining. For example, E0 indicates that the cutting direction at the end of machining is not specified. For example, E1 indicates that the cutting direction at the end of machining is specified to be the forward direction. For example, E2 indicates that the cutting direction at the end of machining is specified to be the return direction.
RR_ represents the amount of escape for the tool T after the cutting operation.
TY_ represents specification of how the outfeed motion or the infeed motion in the cutting operation is performed. For example, TY0 indicates that the outfeed motion or the infeed motion along the periphery of the removal region R is specified. For example, TY1 indicates that the outfeed motion or the infeed motion indicated by a line segment is specified. For example, TY2 indicates that the outfeed motion or the infeed motion indicated by a circular arc is specified.
UD_ represents the amount of the tool T going beyond the removal region R during the outfeed motion.

In this case, the machining condition input unit 14 analyzes the machining program, and reads the machining conditions for cutting processing. For example, in the case of the G130 command shown in FIG. 2A, the machining condition input unit 14 reads the depth of cut made by the tool T in the cutting operation in the forward direction from the address D1, and reads the depth of cut made by the tool T in the cutting operation in the return direction from the address D2. The machining condition input unit 14 reads the feed speed of the tool T in the cutting operation in the forward direction from the address F1, and reads the feed speed of the tool T in the cutting operation in the return direction from the address F2. The machining condition input unit 14 reads the cutting direction at the end of machining from the address E.

The machining condition input unit 14 reads the amount of escape for the tool T after the cutting operation from the address RR. The machining condition input unit 14 reads the specification of the outfeed motion or the infeed motion in the cutting operation and the path type from the address TY. For example, in the case of TY0, the machining condition input unit 14 reads the outfeed motion or the infeed motion through a straight path or a curved path along the periphery of the removal region R. For example, in the case of TY1, the machining condition input unit 14 reads the outfeed motion or the infeed motion through any straight path (a line segment) on the plane formed by the Z axis and the X axis. For example, in the case of TY2, the machining condition input unit 14 reads the outfeed motion or the infeed motion through any curved path (a circular arc) on the plane formed by the Z axis and the X axis. The machining condition input unit 14 reads the amount of the tool T going beyond the removal region R during the outfeed motion from the address UD.

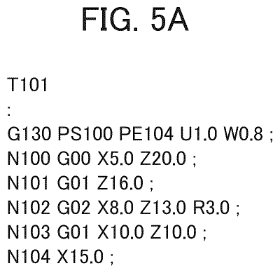

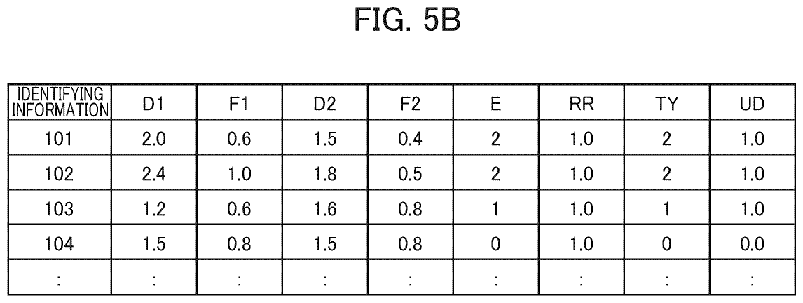

The machining conditions for cutting processing may be previously stored in the storage unit 18. FIG. 5A shows an exemplary machining program for cutting into any shape with a contour including straight portions and a curved portion, and FIG. 5B is an exemplary table showing tool identifying information and machining conditions for machining with each of tools. As shown in FIG. 5B, the storage unit 18 previously stores information indicating association between tool identifying information and machining conditions for machining with each of the tools (D1, D2, F1, F2, E, TY, UD) in the form of a table. As shown in FIG. 5A, the machining program 5 includes specification T_ of the tool identifying information.

In this case, the machining condition input unit 14 may analyze the machining program, and may read the machining conditions corresponding to the tool identifying information from the storage unit 18. This can simplify the machining program 5.

Next, the motion generator 16 will be described. The motion generator 16 generates a reciprocating cutting operation based on the removal region read by the removal region input unit 12 and the machining conditions read by the machining condition input unit 14. Specifically, the motion generator 16 generates cutting operations of the tool T relative to the workpiece W in the forward direction and in the return direction such that the tool T intersects with a yet-to-be-cut portion of the removal region R and such that the amount of this intersection does not exceed the depth of cut to be made by the tool in the forward direction and the depth of cut to be made by the tool in the return direction which are included in the machining conditions. The cutting operations in the forward direction and in the return direction are performed through respective straight paths parallel to the Z axis. The straight paths are directed in opposite directions along the Z axis.

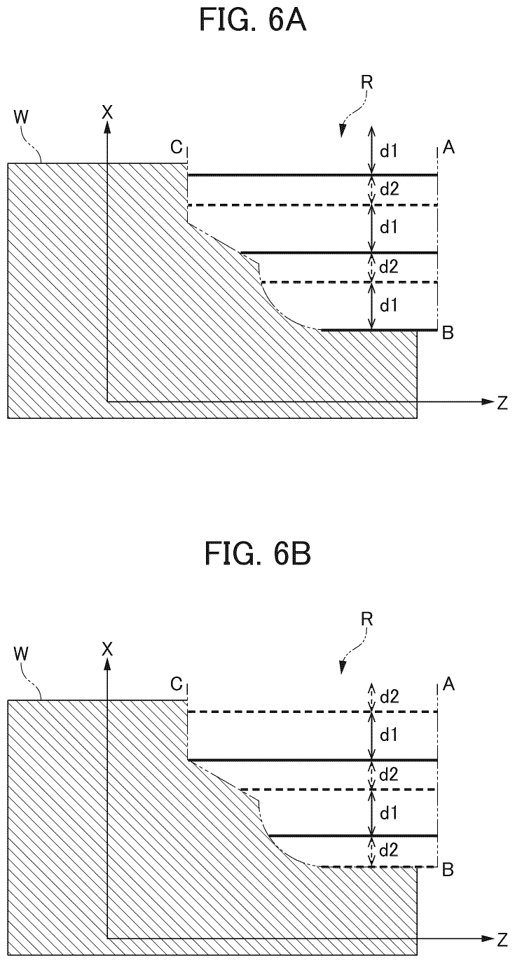

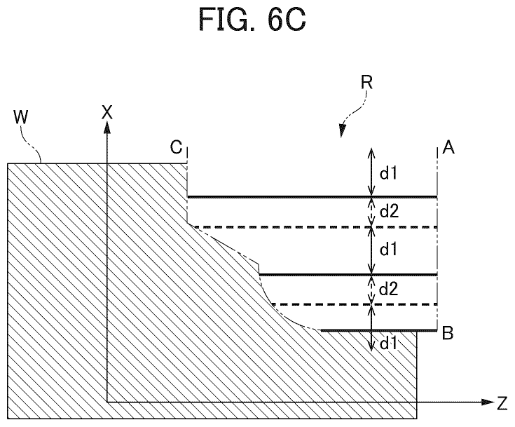

FIGS. 6A to 6C illustrate exemplary cutting operations of a tool in the forward direction and in the return direction generated by the motion generator. In each of FIGS. 6A to 6C, the cutting operations in the forward direction are indicated by the solid lines, the cutting operations in the return direction are indicated by the dashed lines, and the depth of cut in each cutting operation in the forward direction is indicated by d1, and the depth of cut in each cutting operation in the return direction is indicated by d2.

For example, as illustrated in FIG. 6A, if the specification (E) of the cutting direction at the end of machining corresponds to the forward direction, the motion generator 16 alternately generates the cutting operations in the forward direction (the solid lines) at the depth of cut d1 and the cutting operations in the return direction (the dashed lines) at the depth of cut d2 in order from the bottom.

For example, as illustrated in FIG. 6B, if the specification (E) of the cutting direction at the end of machining corresponds to the return direction, the motion generator 16 alternately generates the cutting operations in the return direction (the dashed lines) at the depth of cut d2 and the cutting operations in the forward direction (the solid lines) at the depth of cut dl in order from the bottom.

Alternatively, as illustrated in FIG. 6C, if there is no specification (E) of the cutting direction at the end of machining, the motion generator 16 may alternately generate the cutting operations in the forward direction (the solid lines) at the depth of cut d1 and the cutting operations in the return direction (the dashed lines) at the depth of cut d2 in order from the top.

If the depth of cut in the cutting operation is great enough for the tool to go beyond the removal region R, i.e., if the tool does not intersect with the yet-to-be-cut portion of the removal region, the motion generator 16 terminates creation of the cutting operation. If the depth of cut in the cutting operation is great enough for the tool to go beyond the removal region R as illustrated in FIG. 6C, the motion generator 16 adjusts the depth of cut in the cutting operation that is to be generated in the end so that the depth of cut is not great enough for the tool to go beyond the removal region R. If the depth of cut in the cutting operation is great enough for the tool to go beyond the removal region R, the motion generator 16 may adjust the depth of cut in the cutting operation so that the resultant excess is divided by the number of the plurality of cutting operations and the result is subtracted from the depth of cut in each cutting operation.

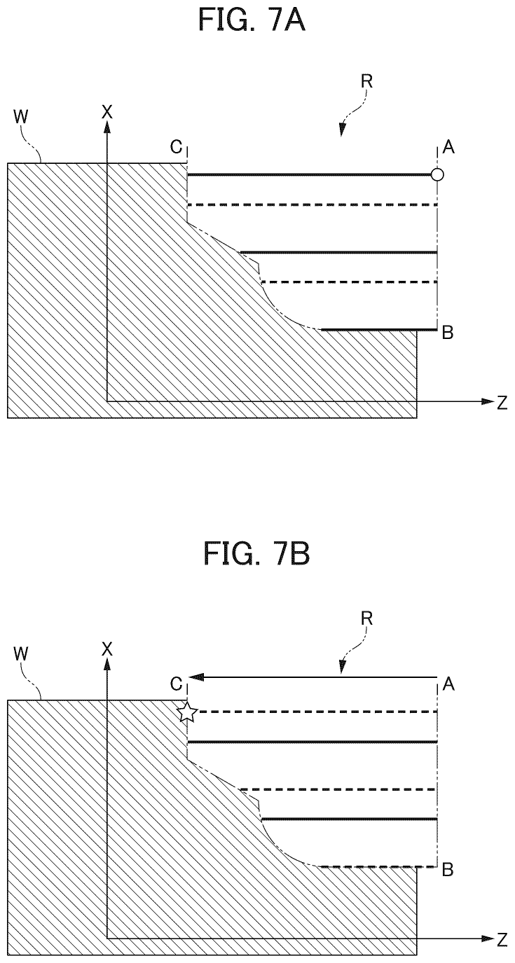

FIGS. 7A and 7B illustrate exemplary approach motions generated by the motion generator. If, as illustrated in FIG. 7A, the Z coordinate of the intersection point (hollow circle) of the tool T and the yet-to-be-cut portion of the removal region R at the start of machining is the same as the Z coordinate of the motion starting point A, there is no need for an approach motion. On the other hand, if, as illustrated in FIG. 7B, the Z coordinate of the intersection point (hollow star) of the tool T and the yet-to-be-cut portion of the removal region R at the start of machining is different from the Z coordinate of the motion starting point A, the motion generator 16 may generate an approach motion in the Z direction from the machining starting point A to the intersection point (a positioning motion, a rapid traverse motion).

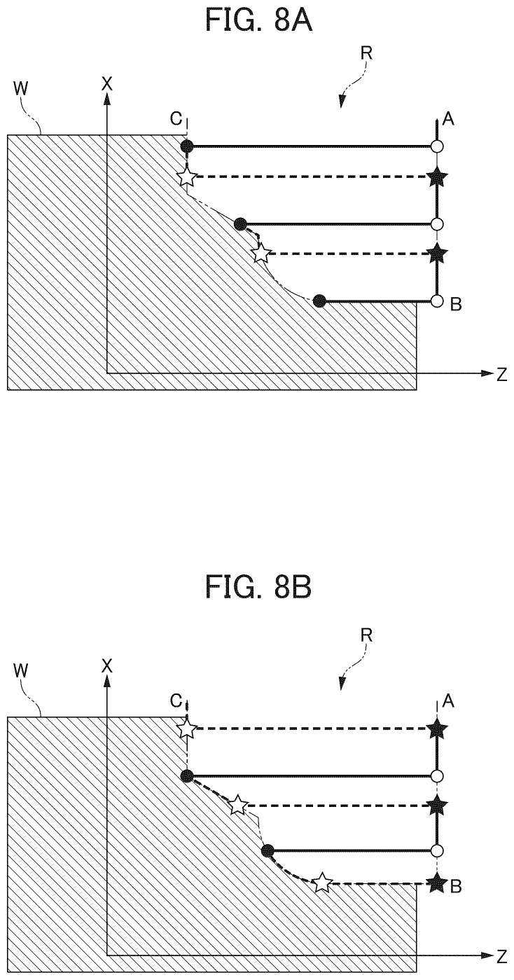

FIGS. 8A and 8B illustrate exemplary switching motions between the cutting operations in the forward direction and the cutting operations in the return direction, generated by the motion generator. In each of FIGS. 8A and 8B, the positions at each of which the cutting operation in the forward direction (the solid line) starts on the periphery of the removal region R are indicated by the hollow circles, and the positions at each of which the cutting operation in the forward direction (the solid line) ends on the periphery are indicated by the solid circles. In each of FIGS. 8A and 8B, the positions at each of which the cutting operation in the return direction (the dashed line) starts on the periphery of the removal region R are indicated by the hollow stars, and the positions at each of which the cutting operation in the return direction (the dashed line) ends on the periphery are indicated by the solid stars.

As illustrated in FIGS. 8A and 8B, the motion generator 16 generates approach motions or infeed motions along the periphery of the removal region R toward corresponding ones of the positions at each of which the cutting operation in the forward direction (the solid line) starts (the hollow circles) and the positions at each of which the cutting operation in the return direction (the dashed line) starts (the hollow stars). The motion generator 16 generates approach motions or infeed motions along the periphery of the removal region R such that the positions at each of which the cutting operation in the forward direction (the solid line) ends (the solid circles) are joined to the adjacent positions at each of which the cutting operation in the return direction (the dashed line) starts (the hollow stars). The motion generator 16 further generates approach motions or infeed motions along the periphery of the removal region R such that the positions at each of which the cutting operation in the return direction (the dashed line) ends (the solid stars) are joined to the adjacent positions at each of which the cutting operation in the forward direction (the solid line) starts (the hollow circles). The infeed motion refers to a motion that allows the tool T to be closer to the yet-to-be-cut portion of the removal region R.

If the moving block in the direction A→B is associated with a rapid traverse command, a motion along the direction A→B merely needs to be an approach motion (a positioning motion, a rapid traverse motion). On the other hand, if the moving block in the direction A→B is associated with a cutting feed command, a motion along the direction A→B merely needs to be an infeed motion (a cutting feed motion). If the moving block in the direction B→C is associated with a cutting feed command, a motion along the direction B→C merely needs to be an infeed motion (a cutting feed motion).

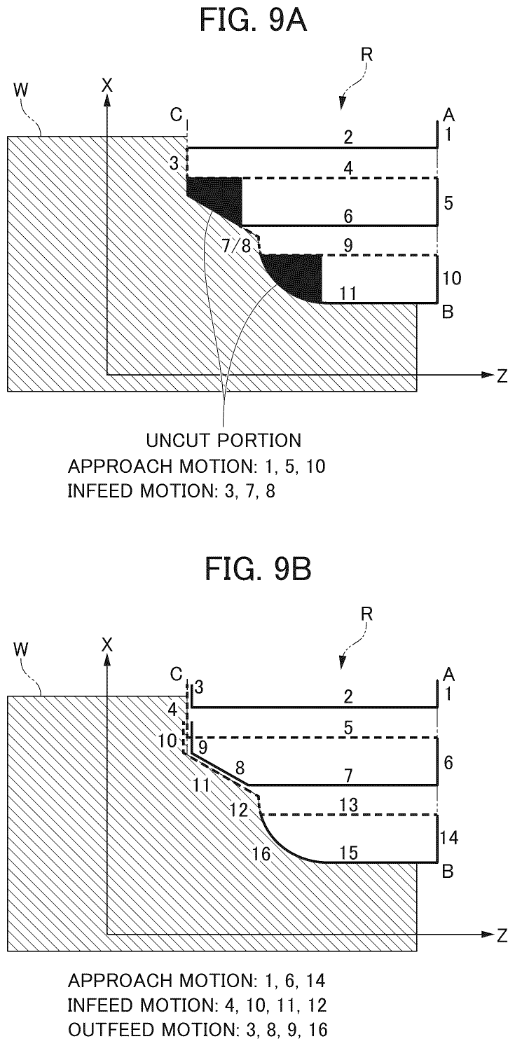

FIGS. 9A and 9B illustrate exemplary outfeed motions along the removal region, generated by the motion generator. To eliminate uncut portions illustrated in FIG. 9A, the motion generator 16 may generate cutting operations in the forward direction (the solid lines) and cutting operations in the return direction (the dashed lines) each including an outfeed motion (TY) along the periphery of the removal region R as illustrated in FIG. 9B. The outfeed motion refers to a motion that allows the tool T to be further from the yet-to-be-cut portion of the removal region R. The outfeed motion may include a going-beyond motion (UD) along the periphery of the removal region R. The going-beyond motion refers to a motion that allows the tool T to go beyond the yet-to-be-cut portion of the removal region R after reaching the yet-to-be-cut portion. In this case, an infeed motion is again performed through a motion in a direction opposite to the direction of the outfeed motion.

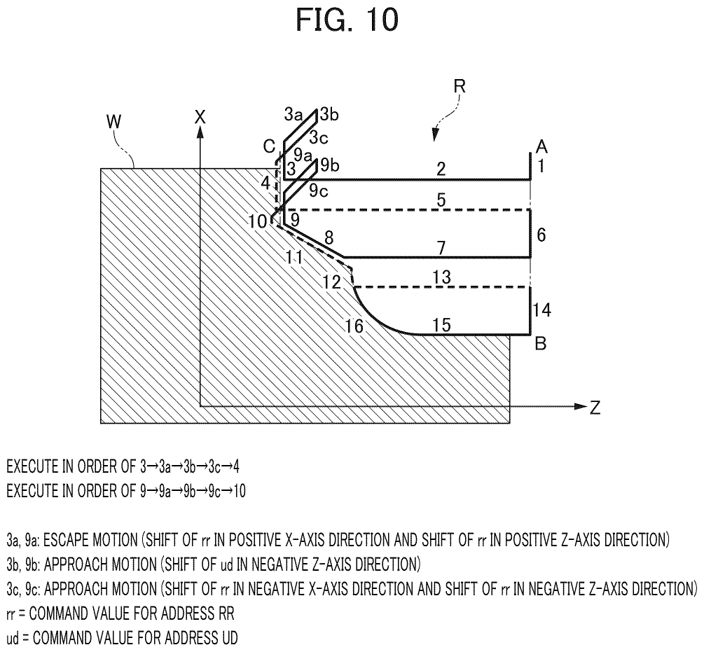

FIG. 10 illustrates exemplary escape motions and exemplary approach motions after the outfeed motions, generated by the motion generator. As illustrated in FIG. 10, the motion generator 16 may generate the cutting operations each including an escape motion (RR) and approach motions after the outfeed motion. The escape motion refers to a motion that allows the tool T to be further from the workpiece R. This can reduce interference between the tool T and the workpiece W. In addition, a cutter mark can be prevented from being formed on the workpiece W.

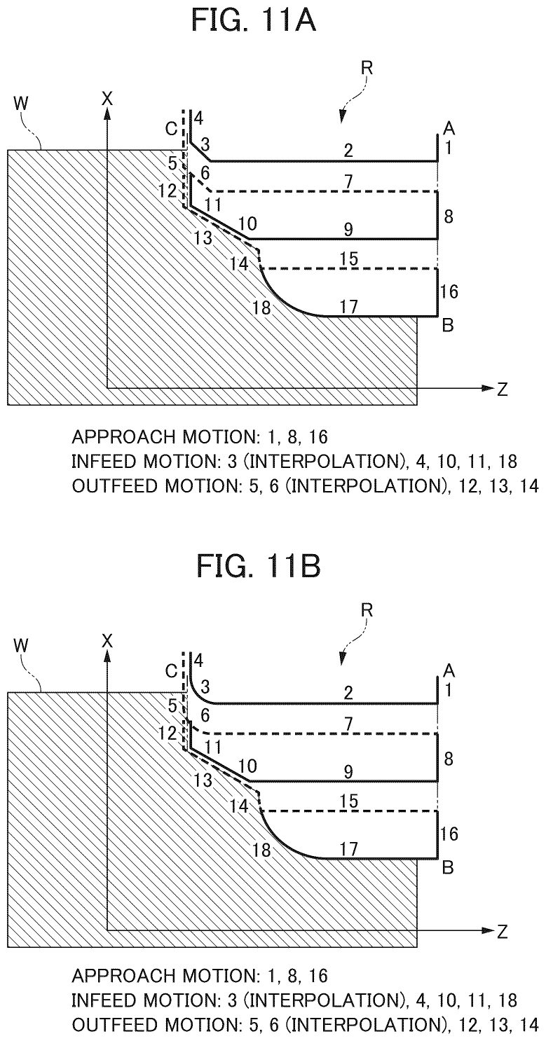

FIGS. 11A and 11B illustrate exemplary outfeed motions and exemplary infeed motions generated by the motion generator. As illustrated in FIG. 11A, the motion generator 16 may generate cutting operations in the forward direction (the solid lines) and cutting operations in the return direction (the dashed lines) each including an infeed motion and an outfeed motion (TY) through any straight path (a line segment) on the plane formed by the Z axis and the X axis. Alternatively, as illustrated in FIG. 11B, the motion generator 16 may generate cutting operations in the forward direction (the solid lines) and cutting operations in the return direction (the dashed lines) each including an infeed motion and an outfeed motion (TY) through any curved path (the circular arc) on the plane formed by the Z axis and the X axis. This can reduce the cutting load on the tool during the infeed motion.

As described above, the motion generator 16 may generate the cutting operations each including an escape motion (RR) and an approach motion after the outfeed motion.

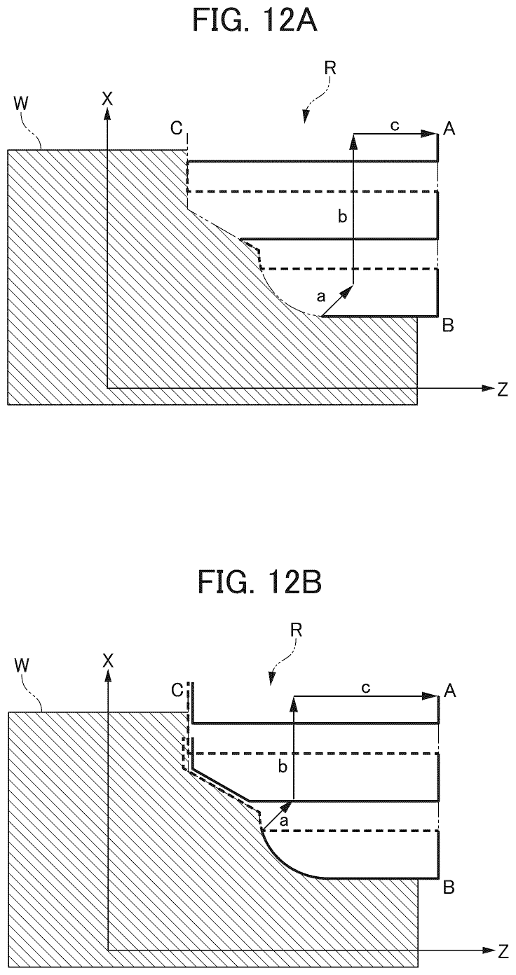

FIGS. 12A and 12B illustrate exemplary escape motions and exemplary approach motions at the end of machining, generated by the motion generator. If, as illustrated in FIGS. 12A and 12B, the depth of cut in the cutting operation is great enough for the tool to go beyond the removal region R, i.e., if the tool does not intersect with the yet-to-be-cut portion of the removal region, the motion generator 16 may generate an escape motion (RR) and an approach motion. If, as illustrated in FIG. 12A, the outfeed motion is not included, the motion generator 16 may generate escape motions a, b, and c after the end of the machining motion. Alternatively, if, as illustrated in FIG. 12B, the outfeed motion is included, the motion generator 16 may generate escape motions a, b, and c after the outfeed motion. The escape motion a corresponds to, for example, a cutting feed. The escape motions b and c correspond to, for example, a rapid traverse that allows the tool T to return to the motion starting point A.

As described above, the numerical controller of the first embodiment performs not only cutting operations in the forward direction but also cutting operations in the return direction. This can shorten the machining time.

The numerical controller of the first embodiment merely needs to specify the shape of the removal region, i.e., the shape of the machined workpiece, in the machining program, and can generate the positions and the amounts of movement in each of the cutting operations in the forward direction and in the return direction from this machining program with consideration given to the depth of cut in each of the cutting operations in the forward direction and in the return direction. Thus, while the cost of introduction of programming support software is reduced, a numerical controller can generate cutting operations in the forward direction and in the return direction without using relatively effective programming support software, such as a computer-aided manufacturing (CAM).

### Second Embodiment

In the first embodiment described above, the cutting into any shape with a contour including straight portions and a curved portion has been described. In a second embodiment, cutting processing for removing a removal region having a shape with only a straight contour, i.e., a rectangular removal region, a removal region including a combination of a rectangular shape and a tapered shape (a right-angled triangular shape), or a tapered (right-angled triangular) removal region will be described.

A numerical controller according to the second embodiment has a configuration that is similar to that of the numerical controller according to the first embodiment illustrated in FIG. 1. The numerical controller according to the second embodiment includes a removal region input unit 12, a machining condition input unit 14, and a motion generator 16 that function and operate in a manner different from that of the numerical controller according to the first embodiment illustrated in FIG. 1.

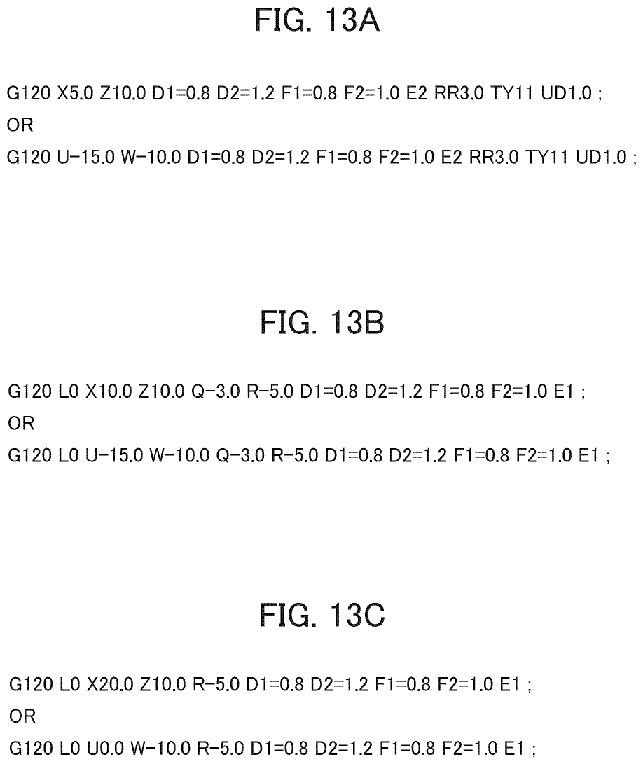

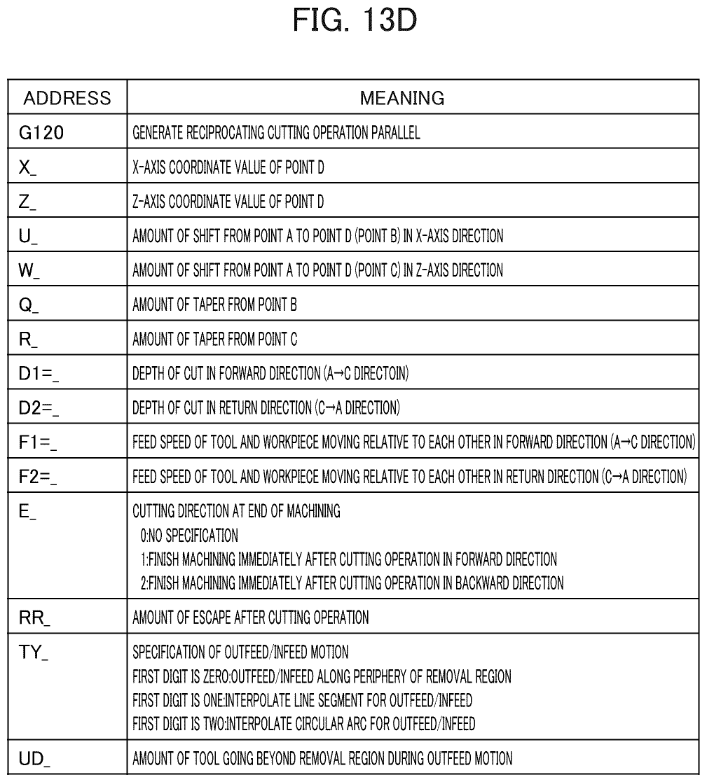

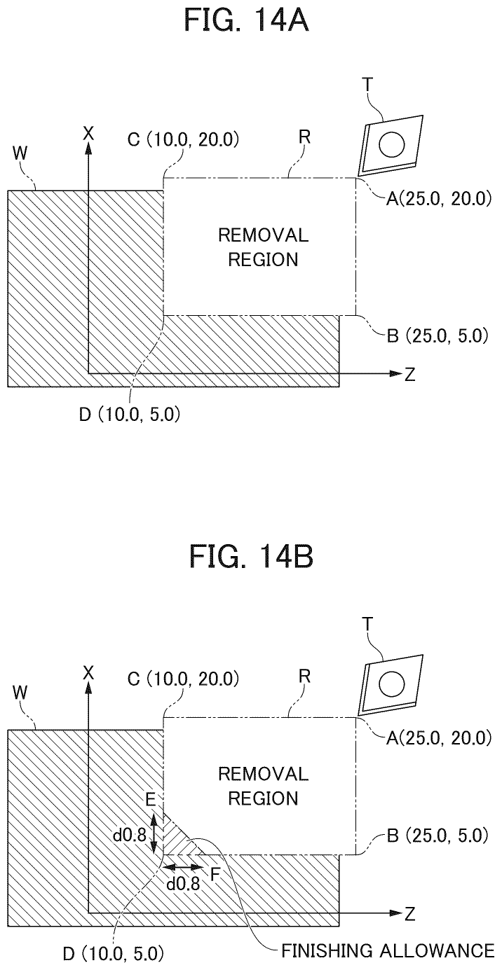

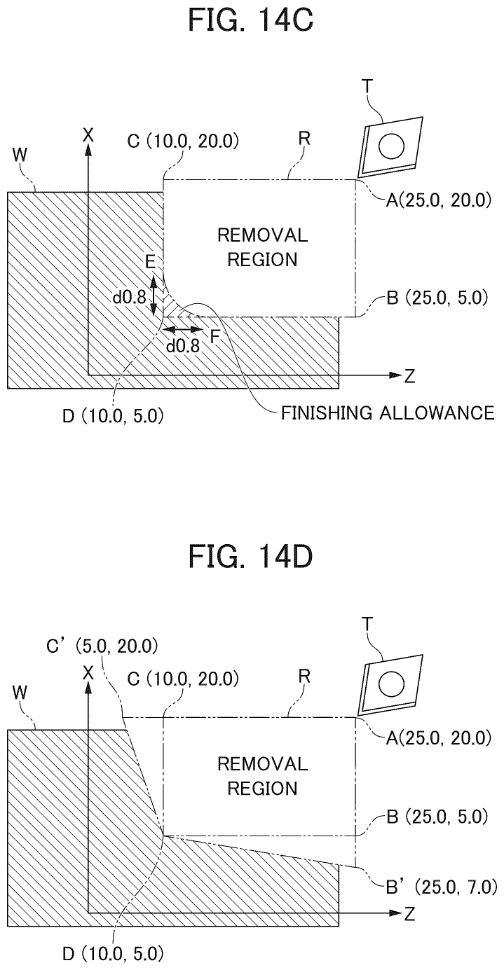

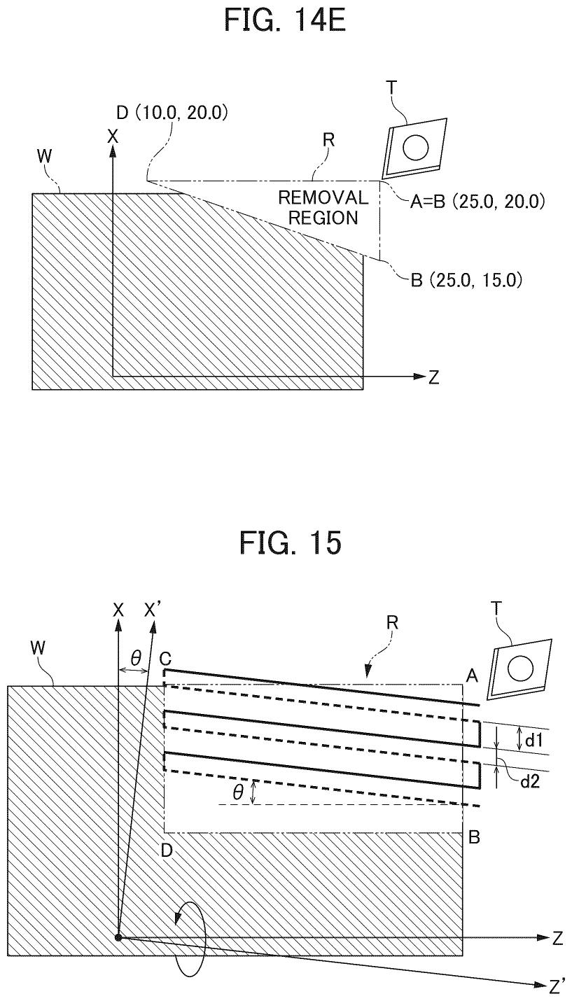

FIG. 13A shows an exemplary machining program for cutting into a shape with only a straight contour, i.e., a rectangular removal region, FIG. 13B shows an exemplary machining program for cutting into a shape with only a straight contour, i.e., a removal region including a combination of a rectangular shape and a tapered shape (a right-angled triangular shape), and FIG. 13C shows an exemplary machining program for cutting into a shape with only a straight contour, i.e., a tapered (right-angled triangular) removal region, and FIG. 13D shows exemplary descriptions of the machining programs shown in FIGS. 13A to 13C. FIGS. 14A to 14C are cross-sectional views illustrating the shape of the removal region indicated by the machining program shown in FIG. 13A and a portion (a half portion above the rotation axis Z) of the contour shape of a machined workpiece, FIG. 14D is a cross-sectional view illustrating the shape of the removal region indicated by the machining program shown in FIG. 13B and a portion (a half portion above the rotation axis Z) of the contour shape of the machined workpiece, and FIG. 14E is a cross-sectional view illustrating the shape of the removal region indicated by the machining program shown in FIG. 13C and a portion (a half portion above the rotation axis Z) of the contour shape of the machined workpiece.

As shown in FIGS. 13A, 13D, and 14A,

G120 represents a command that generates a reciprocating cutting operation parallel to the Z axis by specifying a rectangular region.
X_ represents the X-axis coordinate value (position) of the point D diagonal to the motion starting point A, and Z_ represents the Z-axis coordinate value (position) of the point D.
U_ represents the amount of shift (movement) from the motion starting point A to the point D (in other words, the point B) in the X-axis direction, and W_ represents the amount of shift (movement) from the motion starting point A to the point D (in other words, the point C) in the Z-axis direction.
The X-axis and Z-axis coordinate values of the motion starting point A are determined from the previously stored shape of the workpiece W that is yet to be machined.
As can be seen, the machining program includes the (rectangular) contour shape of the removal region R of the workpiece W to be removed by cutting processing, i.e., the contour shape of the cut workpiece W.

In this case, the removal region input unit 12 analyzes the machining program, and reads the shape of the removal region R of the workpiece W to be removed by cutting processing, from the (rectangular) contour shape of the removal region in the machining program. For example, in the case of the G120 command shown in FIGS. 13A and 14A, the removal region input unit 12 reads the inside of the rectangular shape A-B-D-C as the removal region R from the position (X, Z) of the point D diagonal to the motion starting point A or the amounts of movement (U, W) from the motion starting point A to the point D. The position of the motion starting point A is determined from the previously stored shape of the raw material of the workpiece W that is yet to be machined.

The machining program may include a finishing allowance for finishing. In the second embodiment, instead of the address (U, W) of the first embodiment described above, the address TY for specifying the outfeed motion or the infeed motion includes specification of a finishing allowance.

The removal region input unit 12 may further read the finishing allowance (TY) from the machining program, and may prevent the removal region from including the finishing allowance. For example, in the case of the G120 command shown in FIGS. 13A, 14B, and 14C, the removal region input unit 12 determines a region surrounded by a figure with a total of three vertexes such as the point D and two points E and F that are a predetermined distance d apart from the point D in the X direction and in the Z direction, respectively, to be the finishing allowance.

If the second digit of the address (TY) associated with the finishing allowance is one, the predetermined distance d is determined to be a command value for the depth of cut D1 in the cutting operation in the forward direction. If the second digit is two, the predetermined distance d is determined to be a command value for the depth of cut D2 in the cutting operation in the return direction. If the first digit of the address (TY) associated with the finishing allowance is one, the finishing allowance is determined to have a triangular shape D-E-F as illustrated in FIG. 14B. On the other hand, if the first digit of the address (TY) associated with the finishing allowance is two, the finishing allowance is determined to correspond to a region surrounded by the line segments DE and DF and the circular arc E-F as illustrated in FIG. 14C.

As shown in FIGS. 13B, 13D, and 14D, the machining program may include the contour shape of the removal region R specified as a shape formed by adding a tapered (right-angled triangular) shape to a rectangular shape.

Q_ represents the amount of taper from the point B in the X direction, and R_ represents the amount of taper from the point C in the Z direction.

In this case, the removal region input unit 12 analyzes the machining program, and reads the shape of the removal region R of the workpiece W to be removed by cutting processing, from the contour shape (a rectangular shape and tapered shapes such as right-angled triangular shapes) of the removal region in the machining program. For example, in the case of the G120 command shown in FIGS. 13B and 14D, the removal region input unit 12 reads the inside of the rectangular shape A-B-D-C as a portion of the removal region R from the position (X, Z) of the point D diagonal to the motion starting point A or the amount of movement (U, W) from the motion starting point A to the point D as described above. In addition, the removal region input unit 12 reads the inside of the right-angled triangular shape B-B′-D as another portion of the removal region R from the address (Q) associated with the amount of shift from the point B to the point B′ in the X-axis direction. In addition, the removal region input unit 12 reads the inside of the right-angled triangular shape C-C′-D as still another portion of the removal region R from the address (R) associated with the amount of shift from the point C to the point C′ in the Z-axis direction.

In this manner, the removal region input unit 12 reads a region obtained by combining the inside of the rectangular shape A-B-D-C, the inside of the right-angled triangular shape B-B′-D, and the inside of the right-angled triangular shape C-C′-D together as the removal region R.

As shown in FIGS. 13C, 13D, and 14E, the machining program may include the contour shape of the removal region R specified as only a tapered (right-angled triangular) shape.

In this case, the removal region input unit 12 analyzes the machining program, and reads the shape of the removal region R of the workpiece W to be removed by cutting processing, from the contour shape (a tapered shape such as a right-angled triangular shape) of the removal region in the machining program. For example, in the case of the G120 command shown in FIGS. 13C and 14E, the removal region input unit 12 reads the inside of the right-angled triangular shape B-B′-D as the removal region R from the address (R) associated with the amount of shift from the point B (=the point A) to the point B′ in the Z-axis direction.

As described above, the machining program includes machining conditions (D1, D2, F1, F2, E, RR, UD) for cutting processing. As described above, the machining condition input unit 14 analyzes the machining program, and reads the machining conditions (D1, D2, F1, F2, E, RR, UD) for cutting processing. Then, as described above, the motion generator 16 generates a reciprocating cutting operation based on the removal region read by the removal region input unit 12 and the machining conditions read by the machining condition input unit 14. Specifically, the motion generator 16 generates cutting operations of the tool T relative to the workpiece W in the forward direction and in the return direction such that the tool T intersects with a yet-to-be-cut portion of the removal region R and such that the amount of this intersection does not exceed the depth of cut to be made by the tool in the forward direction and the depth of cut to be made by the tool in the return direction which are included in the machining conditions.

As can be seen from the foregoing description, the numerical controller of the second embodiment also provides advantages similar to those of the numerical controller of the first embodiment.

The embodiments of the present invention have been described above. However, the present invention should not be limited to the above-described embodiments, and various changes and modifications can be made to the present invention. For example, in each of the foregoing embodiments, the cutting operations in the forward direction and in the return direction generated by the motion generator 16 are performed through respective straight paths parallel to the rotation axis of the workpiece W (the Z axis). The straight paths are directed in opposite directions along the rotation axis of the workpiece W (the Z axis). However, this is merely an example of the present invention.

For example, the cutting operations in the forward direction and in the return direction generated by the motion generator 16 may be performed through any straight paths on the plane formed by the rotation axis of the workpiece W (the Z axis) and the orthogonal axis orthogonal to the rotation axis (the X axis). The straight paths may be parallel to each other and may be directed in opposite directions along the rotation axis of the workpiece W (the Z axis). Specifically, as illustrated in FIG. 15, the cutting operation in the forward direction and in the return direction may be performed through respective oblique paths with an angle of inclination θ(0°<θ<90°) relative to the Z axis. In this case,
rotating the Z-X plane clockwise by the angle θ and replacing the depths of cut d1 and d2 with d1 cos θ and d2 cos θ, respectively, allow the same statement as in the second embodiment described above to apply to this example; and
the starting point of creation of a path for a cutting operation merely needs to be the point furthest from the point A in the X′-axis direction (the coordinate axis obtained by rotating the X axis clockwise by the angle θ) (in the example illustrated in FIG. 15, the point D).

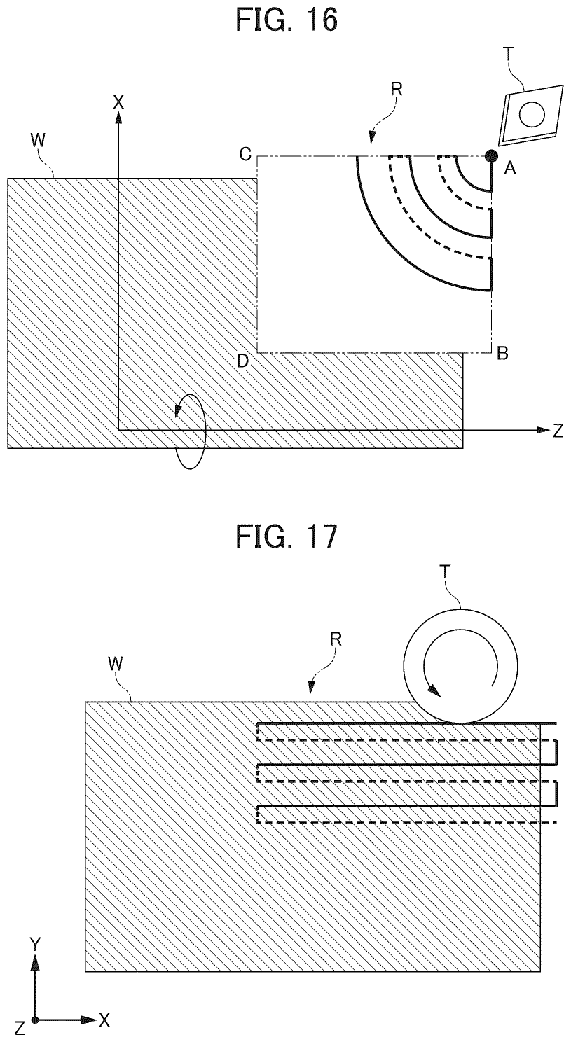

For example, the cutting operations in the forward direction and in the return direction may be performed through any curved paths on the plane formed by the rotation axis of the workpiece W (the Z axis) and the orthogonal axis orthogonal to the rotation axis (the X axis). The curved paths may be parallel to each other, and may be directed in opposite directions along the rotation axis of the workpiece W (the Z axis). Specifically, as illustrated in FIG. 16, the cutting operations in the forward direction and in the return direction may be performed through respective paths along concentric circles about the point A. In this case,
the intersection points of circular arcs about the point A and the periphery of the removal region need to be determined, and these intersection points need to be the starting point and the end point of each of the cutting operations in the forward direction and in the return direction.

The foregoing embodiments illustrate a mode in which the tool is reciprocated relative to the workpiece. However, this is merely an example of the present invention, which is applicable also to a mode in which the workpiece is reciprocated relative to the tool. In other words, the present invention is applicable also to a mode in which the tool and the workpiece are reciprocated relative to each other. In this case, the shift of the tool merely needs to be replaced with reciprocation of the tool and the workpiece relative to each other.

The foregoing embodiments illustrate a mode in which the workpiece is rotated. However, this is merely an example of the present invention, which is applicable also to a mode in which the tool is rotated relative to the workpiece. In other words, the present invention is applicable also to a mode in which the tool and the workpiece are rotated relative to each other. In this case, the rotation of the workpiece merely needs to be replaced with rotation of the tool and the workpiece relative to each other. Examples of such machining include machining (end milling) to be performed with rotation of a tool as illustrated in FIG. 17. FIG. 17 is a view as seen in the +Z direction (from directly above). The cutting operation in the forward direction (the solid lines) is down-cutting (in the −X direction), and the cutting operation in the return direction (the dashed lines) is up-cutting (in +X direction).

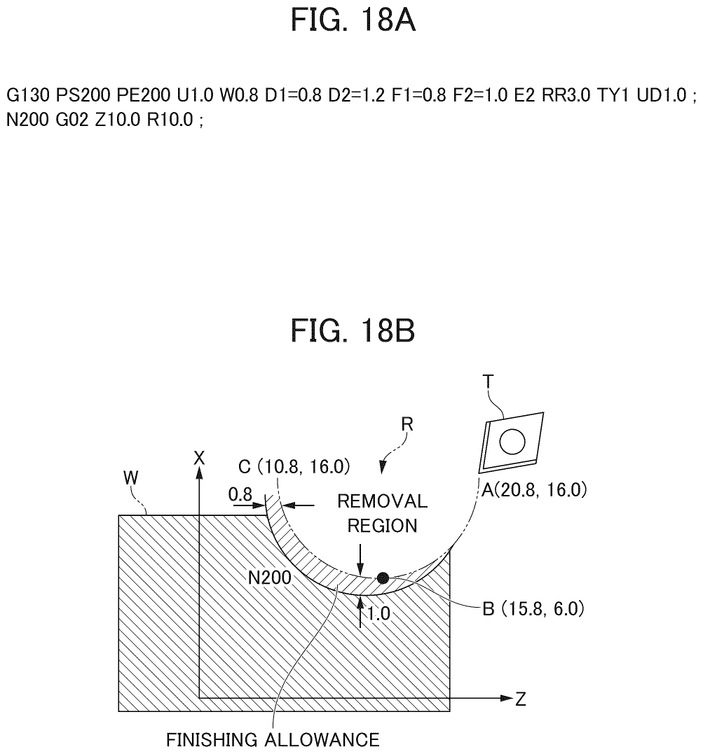

Each of the foregoing embodiments (FIGS. 2A, 3A, 3B, 4A, and 5A) illustrates a mode in which the machining program includes the contour shape of the removal region R of the workpiece W specified by straight lines and a curve (five moving blocks N100 to N104). The total number of the straight lines and the curves is five. However, this is merely an example of the present invention. The machining program may include the contour shape of the removal region R of the workpiece W specified by one or more of straight lines or curves. For example, as illustrated in FIGS. 18A and 18B, the machining program may include the contour shape of the removal region R of the workpiece W specified by only one curve (one moving block N200). In FIG. 18A, the moving block N200 indicates a cutting feed shift to the position Z=10.0 in the Z direction. This cutting feed shift is performed by clockwise circular interpolation with a circular arc radius R of 10.0. In other words, as illustrated in FIG. 18B, the moving block N200 specifies the motion A→B→C in the form of one circular arc. The point B is the lowest point on the circular arc.

### EXPLANATION OF REFERENCE NUMERALS

5 Machining Program
10 Numerical Controller
12 Removal Region Input Unit
14 Machining Condition Input Unit
16 Motion Generator
18 Storage Unit
20 Machine Tool
T Tool
W Workpiece

1. A numerical controller for a machine tool that performs cutting processing of a workpiece by both a cutting operation in a forward direction and a cutting operation in a return direction by relatively rotating a tool and the workpiece while relatively reciprocating the tool and the workpiece, the numerical controller comprising:
a removal region input unit configured to analyze a program for the cutting processing, and to read a shape of a removal region of the workpiece to be removed by the cutting processing;
a machining condition input unit configured to read machining conditions for the cutting processing, the machining conditions including at least a depth of cut to be made by the tool in the cutting operation in the forward direction and a depth of cut to be made by the tool in the cutting operation in the return direction; and
a motion generator configured to generate the cutting operation in the forward direction and the cutting operation in the return direction, based on the shape of the removal region and the machining conditions, such that the tool intersects with a yet-to-be-cut portion of the removal region and such that an amount of intersection does not exceed the depth of cut to be made by the tool in the forward direction and the depth of cut to be made by the tool in the return direction.

2. The numerical controller according to claim 1, wherein
the cutting operation in the forward direction and the cutting operation in the return direction generated by the motion generator are performed through straight paths parallel to a rotation axis of the workpiece or any straight or curved paths on a plane formed by the rotation axis of the workpiece and an orthogonal axis orthogonal to the rotation axis,
the paths are parallel to each other, and
the paths are directed in opposite directions along the rotation axis of the workpiece.

3. The numerical controller according to claim 1, wherein
the program includes a contour shape of the removal region specified as a right-angled triangular shape, a rectangular shape, or a shape formed by adding a tapered shape to a rectangular shape, and
the removal region input unit reads the shape of the removal region from the contour shape of the removal region in the program.

4. The numerical controller according to claim 1, wherein
the program or a subprogram of the program includes a contour shape of the removal region specified by one or more of straight lines or curves, and
the removal region input unit reads the shape of the removal region from the contour shape of the removal region in the program.

5. The numerical controller according to claim 1, wherein
the program further includes a finishing allowance for finishing,
the removal region input unit
further reads the finishing allowance from the program, and
prevents the removal region from including the finishing allowance or translates the removal region by the finishing allowance.

6. The numerical controller according to claim 1, wherein the machining conditions to be read by the machining condition input unit and to be used by the motion generator further include at least
a feed speed of the tool and the workpiece relative to each other in the cutting operation in the forward direction and a feed speed of the tool and the workpiece relative to each other in the cutting operation in the return direction,
an amount of escape for the tool and the workpiece relative to each other after each cutting operation,
an infeed motion of the tool and the workpiece relative to each other in each cutting operation,
an outfeed motion of the tool and the workpiece relative to each other in each cutting operation, or
whether a cutting direction at an end of the cutting processing is set to be the forward direction or the return direction.

7. The numerical controller according to claim 6, wherein
a path for each infeed motion or a path for each outfeed motion is a straight or curved path along a periphery of the removal region or an any straight or curved path on a plane formed by a rotation axis of the workpiece and an orthogonal axis orthogonal to the rotation axis.

8. The numerical controller according to claim 1, wherein
the program further includes the machining conditions, and
the machining condition input unit analyzes the program, and reads the machining conditions from the program.

9. The numerical controller according to claim 1 further comprising: a storage unit configured to store the machining conditions associated with identifying information for the tool,
the program further including the identifying information for the tool,
the machining condition input unit reading the machining conditions corresponding to the identifying information for the tool from the storage unit, the identifying information for the tool being read from the program.

10. The numerical controller according to claim 1, wherein the motion generator
determines a predetermined point on a periphery of the removal region to be a point at which the cutting operation in the forward direction starts or a point at which the cutting operation in the return direction starts, and
generates an approach motion of the tool and the workpiece relative to each other toward the point at which the cutting operation in the forward direction starts or the point at which the cutting operation in the return direction starts.

11. The numerical controller according to claim 1, wherein the cutting operation in the forward direction or the cutting operation in the return direction generated by the motion generator includes at least
an infeed motion of the tool and the workpiece relative to each other in a direction in which the tool approaches the yet-to-be-cut portion of the removal region, or
an outfeed motion of the tool and the workpiece relative to each other in a direction in which the tool moves away from the yet-to-be-cut portion of the removal region.

12. The numerical controller according to claim 1, wherein the cutting operation in the forward direction or the cutting operation in the return direction generated by the motion generator includes an escape motion or an approach motion of the tool and the workpiece relative to each other in a direction in which the tool moves away from the workpiece.

13. The numerical controller according to claim 1, wherein in a case in which the tool does not intersect with the yet-to-be-cut portion of the removal region, the motion generator generates an escape motion of the tool and the workpiece relative to each other in a direction in which the tool moves away from the workpiece.
